(19) United States
(12) Patent Application Publication
(10) Pub. No.: US 2019/0233337 A1
(43) Pub. Date: Aug. 1, 2019

(54) FIBER REINFORCED CARBON AND REFRACTORY CERAMICS COMPOSITES

(71) Applicant: The Government of the United States of America, as represented by the Secretary of the Navy, Arlington, VA (US)

(72) Inventors: Matthew Laskoski, Springfield, VA (US); Tristan Butler, Alexandria, VA (US); Teddy M. Keller, Fairfax Station, VA (US); Stephen M. Deese, Alexandria, VA (US); Mehana Daftary, Potomac, MD (US)

(73) Assignee: The Government of the United States of America, as represented by the Secretary of the Navy, Arlington, VA (US)

(21) Appl. No.: 16/260,465

(22) Filed: Jan. 29, 2019

Related U.S. Application Data
(60) Provisional application No. 62/624,267, filed on Jan. 31, 2018.

(51) Int. Cl. C04B 35/58; C04B 35/52; C04B 35/83; C04B 35/76

(52) U.S. Cl. CPC C04B 35/58078; C04B 35/522; B82Y 30/00; C04B 35/58071; C04B 35/76; C04B 35/83

(57) ABSTRACT

Disclosed is a composition having nanoparticles or particles of boron, a refractory metal, or a refractory metal hydride; organic compound having a char yield of at least 60% by weight or a thermoset made from the organic compound; and a reinforcing material. The metal and organic are combined with the reinforcing material. The mixture is heated for make a ceramic having nanoparticles of a boron or refractory metal nitride, boride, or carbide; a reinforcing material; and a carbonaceous matrix. The ceramic is not a powder.

This application claims the benefit of U.S. Provisional Application No. 62/624,267, filed on Jan. 31, 2018. The provisional application and all other publications and patent documents referred to throughout this nonprovisional application are incorporated herein by reference.

### TECHNICAL FIELD

The present disclosure is generally related to synthesis of reinforced metal carbides, borides, and nitrides.

### DESCRIPTION OF RELATED ART

As technological advancements in high speed propulsion systems have progressed, the need for materials that can withstand the harsh conditions necessitated by this application has become increasingly important. These materials will experience temperatures well in excess of 2000° C., which severely limits the pool of available materials. Not only must potential materials exhibit high melting points, they also require robust oxidation resistance as well as the ability to endure high mechanical stresses. Though suitable materials are scarce, ultra-high temperature ceramics (UHTCs) such as transition metal borides, nitrides, and carbides melt at temperatures greater than 3000° C., thereby exceeding the temperature threshold required for high-temperature applications. In addition, UHTCs also possess thermal and mechanical properties desirable for applications such as ballistic armor, wear resistant materials, as well as polishing and cutting materials. Some UHTCs such as B₄C, also exhibit high neutron absorption making them desirable synthetic targets for nuclear applications.

Many strategies have been employed to synthesize UHTC ceramics including formation from reactive vapor phases, liquid phases under autogenous pressure, as well as the borothermal reduction of solid precursors. However, these methods are plagued by high manufacturing costs that result from the complex setups needed to achieve the high temperatures and pressures that facilitate reaction. One strategy to reduce manufacturing cost is through the carbothermal reduction of boron and metal precursors in a polymeric matrix. In this method, ceramic phases are formed in situ at lower temperatures than corresponding powder methods. This method also shows potential for further cost reductions due to the malleability of polymeric precursors, which can be used to form shaped ceramic materials for a given application.

However, these materials are quite brittle which leads to low fracture toughness, and poor thermal shock resistance, ultimately limiting their application. In order to mitigate these effects, numerous Zr-based composite materials have been fabricated using a variety of reinforcement phases (carbon nanotubes, carbon fiber, silicon carbide fibers). While this strategy has been effectively used to bolster the mechanical performance of these materials, obtaining materials with adequate hardness and densities can be quite costly. For example, processing methods such as chemical vapor infiltration (CVI), reactive melt infiltration (RMI) and polymer infiltration and pyrolysis (PIP) are often coupled together in order produce fully dense materials. The added processing complexity increases the cost and also limits the scalability of these technologies. Therefore, alternative routes to fabricate reinforced UHTC materials are critical to incorporating them in high speed applications.

Similar to reinforced UHTC materials, carbon/carbon (C/C) composites are also useful for high-stress aerospace applications because it is a low density material with robust thermal and mechanical properties. However, C/C composites show poor ablation resistance and can only be heated to 729° C. before exhibiting oxidation and limiting their high-temperature applications. One strategy for improving these properties is to introduce a secondary UHTC component into the C/C composite. The method described herein presents a straightforward method for producing C/C composites reinforced with UHTC materials.

### BRIEF SUMMARY

Disclosed herein is a composition comprising: nanoparticles of a boron or refractory metal nitride, boride, or carbide; a reinforcing material; and a carbonaceous matrix. The composition is not in the form of a powder.

Also disclosed herein is a composition comprising: a metal component selected from nanoparticles or particles of boron, a refractory metal, or a refractory metal hydride; an organic component selected from an organic compound having a char yield of at least 60% by weight and a thermoset made from the organic compound; and a reinforcing material.

Also disclosed herein is a method comprising: combining to form a precursor mixture, a metal component selected from nanoparticles or particles of boron, a refractory metal, or a refractory metal hydride; and an organic compound having a char yield of at least 60% by weight; milling the precursor material; and combining the precursor material with a reinforcing material.

### BRIEF DESCRIPTION OF THE DRAWINGS

A more complete appreciation will be readily obtained by reference to the following Description of the Example Embodiments and the accompanying drawings.

FIG. 1 schematically illustrates a process for forming the disclosed compositions.

FIG. 2 schematically illustrates particles 10 and fibers 25 embedded in a thermoset matrix 20.

FIG. 3 schematically illustrates the transfer 40 of carbon atoms from the carbon matrix 30 to the nanoparticle 50.

FIG. 4 schematically illustrates nanoparticles 50 and fibers 25 in a carbonaceous matrix 70

FIG. 5A shows XRD data and FIG. 5B shows SEM images of a TiB₂/carbon fiber sample.

FIG. 6A shows XRD data and FIG. 6B shows SEM images of a TiB₂/woven carbon fiber sample.

FIG. 7 shows XRD data of a TiB₂/phthalonitrile sample.

FIG. 8A shows XRD data and FIG. 8B shows SEM images of a carbon/carbon fiber sample.

FIG. 9A shows XRD data and FIG. 9B shows SEM images of a TiC/carbon/carbon fiber sample.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

This disclosure concerns a polymeric synthetic process and method for the in situ fabrication of ultra-high temperature nanosized ceramic (UHTC) materials (e.g. metal boride, carbide, and nitrides) reinforced with homogeneously dispersed reinforcement phases (e.g. carbon nanotubes, carbon fibers, and ceramic fibers such as silicon carbide). Composites are formed by the formulation of Group III-VI metal precursor compositions and a reinforcement phase followed by the thermal conversion to fiber reinforced nanosized shaped ceramic composites. In addition, reinforced composites can also be made from fabric preforms that are infiltrated with a metal/carbon polymeric precursor. Conversion to ceramic phases is accomplished by heating such samples under an inert atmosphere (nitrogen and/or argon) in a single-step process. The synthetic method offers the ability to tune crystallite grain size, density, shape, mechanical properties, hardness, radiation shielding, and electrical/thermal conductivity within the ceramic composites.

Ceramic composites made from UHTC materials are often formed via a method that subjects preformed transition metal carbide/boride powders to hot-press sintering, which requires high pressures (>200 MPa) and temperatures (>2000° C.) to achieve adequate densities. The powdered metal carbide and boride precursors are often synthesized in an additional energy-intensive step from metal particles, salts, oxides, and carbon (graphite or amorphous carbon) in a reducing hydrogen atmosphere at high temperatures (>2000° C.) to ensure high conversion. For example, titanium diboride (TiB₂) is often synthesized at high temperatures via the borothermal reduction of TiO₂ using carbon and a boron source (e.g. B₄C, B₂O₃, B). As mentioned above, a subsequent hot-pressing step is required for full densification. As a result of these harsh reaction conditions and the complex machinery needed to achieve them, the multi-step fabrication of UHTC materials can be quite costly.

The high temperatures required to currently produce fully dense UHTCs from powders can also lead to increased grain coarsening which can embrittle these materials, thereby limiting their use in applications with stringent mechanical requirements. To improve the mechanical properties of UHTC ceramics, fabrication of composite materials with reinforcement phases containing carbon nanotubes (CNTs), carbon and/or silicon carbide and other ceramic fibers can dissipate mechanical stress through a variety of mechanisms (e.g. crack deflection, bridging, debonding, and fiber pullout). For example, HfB₂, ZrB₂, and TiB₂ materials reinforced with CNTs all exhibit enhanced hardness, flexural strength, and fracture toughness compared to monolithic samples. Yet, fully dense reinforced ceramic materials can be difficult to realize, as the elevated temperatures required for their synthesis can result in fiber degradation. Additionally, poor dispersion of reinforcement phases can also hinder densification, which limits the mechanical performance of these materials. Therefore, synthetic methods must be established which can improve dispersion of reinforcement phases under more mild conditions in order to optimize the mechanical properties of UHTC composites.

The synthesis method uses a two-step process for the low-cost production of a variety of reinforced UHTC materials. The first step mixes together a precursor composition containing the following key ingredients: (1) metal sources (metal powder and/or metal hydride micro/nanopowder, such as W, Ta, Hf/HfH₂, Ti/TiH₂, Nb/NbH₅, Si, B, and Zr/ZrH₂); and (2) a carbonaceous high char yield resin and reinforcement fibers. Reinforcement phases (carbon, SiC, ceramic fibrous components) can be mixed with the ceramic precursor material by milling or by preparing a suspension of precursor and reinforcement phase followed by evaporation of solvent. In addition, a slurry can be used to impregnate woven fiber preforms with ceramic precursor. Materials are converted into shaped thermoset solids at temperatures below 500° C., followed by further heating to 1000-1500° C. in order to form ceramic matrix composite. The precursor composition can be tailored for specific applications. Different metal precursors and high char yield resins can be used to produce different composites. Composite samples with woven reinforcement phases can also be used. Ceramic phases such as UHTCs can be used to enhance the thermal, mechanical, and ablation properties of carbon-carbon (C/C) composites. For instance, incorporation of ZrC within a C/C composite has been shown to improve ablation properties.

A polymeric method was developed which can be used to fabricate ceramic (borides, carbides, nitrides) composites of a variety of refractory metals (Ti, W, Nb, Zr, Mo, Cr, V, Ta, and Hf) that contain reinforcement phases (carbon nanotubes, continuous and short chopped carbon and SiC fibers, other ceramic phases and fibers) to improve mechanical, thermal and oxidative properties. These composites are formed in situ by a chemical reaction between elemental metals or metal hydrides and high char-yield polymeric resins that act as the carbon source as well as binding the ceramic material together.

Precursor mixtures are obtained by mixing/milling together 1) a metal source (metal particle or metal hydride) with 2) a thermosetting resin with a high-char yield. For boride samples, boron powder is added to the precursor composition. Ceramic phases were derived from 1,2,4,5-tetrakis(phenylethynyl)benzene (TPEB) and a resorcinol based phthalonitrile resin (Res), however this method could be adapted for other resin systems (e.g. epoxy, phenolic, phthalonitrile, polycarborane-silyloxyl-acetylene (PCSA)) with suitable char yields. Depending on the requirements of the desired composite, resins can be B-staged at temperatures in excess of 150° C., which enables crosslinking and eventual formation of the thermoset. The viscosity of the resin, a useful parameter for formation of the greenbody, can be controlled by varying the duration of B-staging.

Short chopped reinforcement phases can be added to the precursor mixture prior to milling, or after the fact depending on the target composite. In the latter case, a suspension of the precursor is prepared with the reinforcement phase dispersed in ethanol. Fiber dispersion in the composite can be improved through the addition of an epoxy resin to the precursor/reinforcement suspension. This helps adhere the precursor phase to the reinforcement thereby aiding in the formation of a more uniform green body. Additionally, the precursor can be used to infiltrate woven fiber preforms to form composites with continuous reinforcement. Depending on the ratio of metal to resin, both C/C and purely ceramic composites can be fabricated. Upon further manipulation of the resin-to-metal ratio, C/C composites can be prepared which contain ceramics as secondary reinforcement phases. In addition, boron and Si precursor compositions can be formulated and use in the fabrication of boride carbide/nitride and silicon carbide/nitride composite components in a similar manner.

Consolidation of the green body is done using a hydraulic press either at elevated (>150° C.) or ambient temperatures depending on the desired B-staging of the resin. For materials with short chopped fibers, a shaped thermoset is formed with the metal source and reinforcement phase embedded in a rigid polymer matrix. Since resin flow is needed to fuse together the layers of the composite, pressing at elevated temperatures is required for the formation of green bodies from precursor composition impregnated woven fabrics. For these samples, formation of the thermoset binds the sample and adheres the metal source to the reinforcement phase. Subsequently, the green bodies are thermally converted to their corresponding ceramic phase by heating to 1500° C. under inert conditions. When no metal source is included in the precursor mixture, carbonization of the resin only forms carbon phases (amorphous, nanotube, graphitic, etc.). However, carbonization of the resin in metal-containing green bodies results in the reaction between carbon atoms and metal species to form carbide phases. Additionally, reactions between metal species and other inclusions can also occur. For example, when boron powder is present in the precursor mixture, boride phases are formed. Additionally, metal nitrides can be formed when heated under flowing nitrogen.

High char-yield resins can be used to form metal carbide, boride, and nitride composite materials, which contain a variety of reinforcement phases. Using this approach, composites can be made with either short chopped fiber reinforcements, woven fiber, and/or unidirectional (prepreg) fiber preforms. Densities above 85% observed after carbonization. The ratio of resin to metal can be altered in order to form purely carbon composites, carbon composites with secondary ceramic phases, and purely ceramic composite materials. This facile synthetic strategy can be slightly altered in order to form a variety of reinforced carbon and ceramic composite materials, which is potentially more cost effective than current methods.

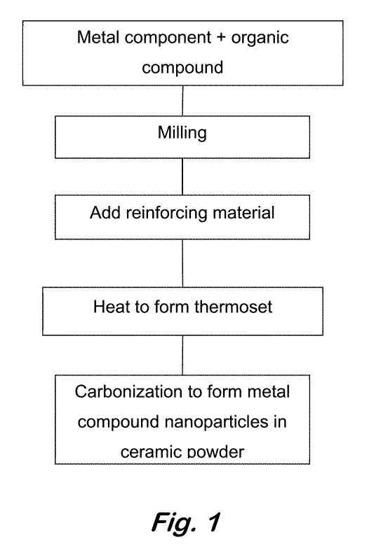

One method (FIG. 1) starts with a metal component, an organic compound, and a reinforcing material. The metal component may be nanoparticles or particles of boron, a refractory metal, or a refractory metal hydride. Suitable metal components include, but are not limited to, titanium and boron.

The organic compound has a char yield of at least 60% by weight, or is a thermoset made from such a compound. The char yield may also be as high as at least 70%, 80%, 90%, or 95% by weight. The char yield of a potential compound may be determined by comparing the weight of a sample before and after heating to at least 1000° C. for at least 1 hr in an inert atmosphere such as nitrogen or argon. Any such compounds with high char yields may be used as the charring may play a role in the mechanism of the reactions. This char yield may be measured at an elevated pressure to be used when a heating step is also performed at such pressure. Thus, a compound having a low char yield at atmospheric pressure but having a high char yield under the conditions that the disclosed methods are performed may be suitable.

Certain organic compounds may exhibit any of the following characteristics, including mutually consistent combinations of characteristics: containing only carbon and hydrogen; containing aromatic and acetylene groups; containing only carbon, hydrogen, and nitrogen or oxygen; containing no oxygen; and containing a heteroatom other than oxygen. It may have a melting point of at most 400° C., 350° C., 300° C., 250° C., 200° C. or 150° C. and the melting may occur before polymerization or degradation of the compound. Examples of organic compounds include, but are not limited to, 1,2,4,5-tetrakis(phenylethynyl)benzene (TPEB) or a prepolymer thereof, an epoxy, a phenolic, a phthalonitrile, and polycarborane-siloxy-acetylene. Prepolymers may also be used, such as a prepolymer of TPEB or other suitable organic compounds. Different compounds can be blended together and/or reacted to a prepolymer stage before usage as the organic compound of the precursor composition. The presence of nitrogen atoms in the organic compound may produce metal nitrides in the ceramic without the use of a nitrogen atmosphere.

The reinforcing material may be a material such as carbon nanotubes, carbon fibers, or silicon carbide fibers, and may be in the form of woven fabric, chopped fibers, or unidirectional fibers.

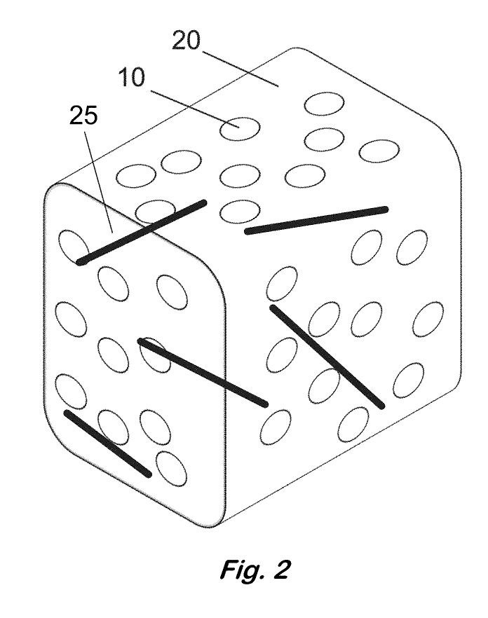

The three components are then combined. The metal and organic are optionally milled before adding the reinforcing material. The mixture is heated in an inert atmosphere such as nitrogen or argon. The heating is performed at a temperature that causes decomposition or reaction of the metal component to form nanoparticles in a metal nanoparticle composition. In this step, a metal hydride may decompose to form metal nanoparticles. The organic compound may also polymerize to a thermoset so that the metal nanoparticle composition will have a fixed shape. The shape may be determined by placing the initial components in a mold. The metal particles 10 and fibers 25 would then be dispersed throughout the thermoset 20 as shown in FIG. 2.

In a second heating step, the metal nanoparticle composition is heated in an inert atmosphere, argon, or nitrogen at a temperature that causes formation of a ceramic comprising boron or refractory metal nitride, boride, or carbide nanoparticles and the reinforcing material in a carbonaceous matrix. This ceramic material may have the same shape as the metal nanoparticle composition, and in this case would not be a powder.

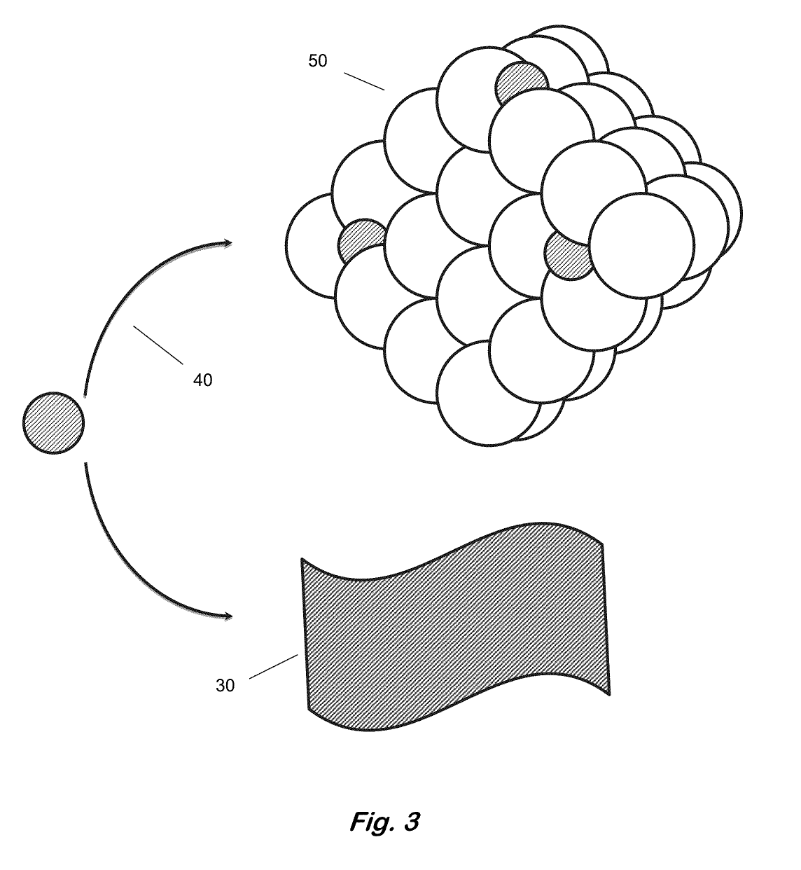

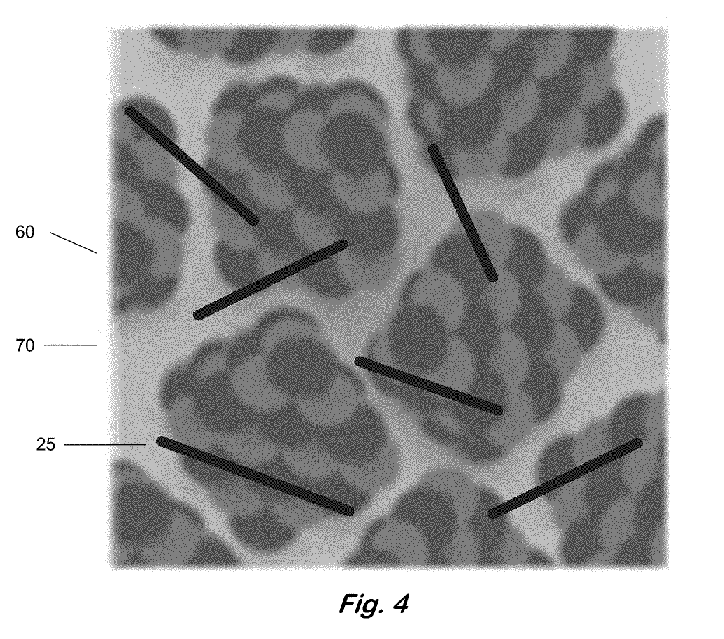

FIG. 3 schematically illustrates the transfer 40 of carbon atoms from the carbon matrix 30 to the nanoparticle 50. FIG. 4 schematically illustrates nanoparticles 50 and fibers 25 in a carbonaceous matrix 70. Example heating steps and precursor materials are disclosed in U.S. Pat. Nos. 8,822,023; 8,865,301; 8,815,381; 8,778,488; and 10,189,747.

The nanoparticles in the ceramic may be for example, titanium boride, boron carbide, or titanium carbide. The ceramic may comprise, for example, at least 5%, 10%, 50%, 90%, 95%, or 99% by weight of the nanoparticles and/or filler. The balance of carbonaceous matrix may be a small amount sufficient to adhere the nanoparticles together. As the nanoparticles are formed in situ, there is no particular minimum amount of matrix required.

Variations on the method may be summarized as follows.

Chopped fiber reinforced: powdered metal or metal hydride+high char yield resin (staging optional)+milling→precursor composition+reinforcement+epoxy resin (optional)→press+cure to thermoset→heat to 1500° C. in either nitrogen (metal nitrides) or argon (metal carbides/borides).

Continuous fiber reinforced: powdered metal or metal hydride (optional)+high char yield resin (staging optional)+Milling→precursor composition+impregnation of woven fabric→press+cure to thermoset→heat to 1500° C. in either nitrogen (metal nitrides) or argon (metal carbides/borides).

Unidirectional fiber reinforced: powdered metal or metal hydride (optional)+high char yield resin (staging optional)+milling→precursor composition+formulation of unidirectional prepreg→press+cure to thermoset→heat to 1500° C. in either nitrogen (metal nitrides) or argon (metal carbides/borides).

Potential advantages and features of the disclosed products and methods include the following.

The method allows for synthesis of reinforced metal carbide, boride, and nitride ceramics in high-yield and high purity.

The method is adaptable to different composition reinforcement phases and both chopped and continuous additives.

Composite materials can be synthesized in a single step, which enables potential cost reductions compared to current strategies.

Enhanced processability derived from the thermosetting resin allows for the fabrication of shaped composites.

High char yield resin can be B-staged at elevated temperatures in order to alter viscosity and optimize processing parameters.

Different thermosetting resins can be used to fabricate ceramics, which allows for tailoring of resin properties to specific ceramic targets.

Resin-to-metal ratio can be adjusted to form purely carbon composites, carbon composites with secondary ceramic phases, and entirely ceramic composites.

Ceramic composites are formed with nanocrystalline domains, which typically leads to more desirable properties.

Fiber dispersion can be improved by including a secondary epoxy resin, which helps adhere precursor powder to reinforcement phases.

Process for the low temperature synthesis of reinforced composites can be adapted to form oxides, silicides, and other temperature resistant materials.

Fiber reinforced ceramic composite can be processed in a similar manner as currently used for the fabrication of carbon-carbon composite.

Examples of applications that could benefit from materials produced via this method include high-temperature engine components that can be fabricated from reinforced UHTC materials, as they will need to withstand high temperatures and stresses. Both C/C composites and reinforced UHTC materials also show promising in heat shielding applications. Given that this method can be adapted to form both of these composites, this technology is uniquely suited to examine a variety of composite compositions—increasing the likelihood of developing an effective material. A railgun could also benefit from this technology as high-temperature, conductive, and wear-resistant materials are needed to improve durability of the rails and the projectiles. In addition, fabrication of kinetic projectiles (i.e. ammunition for railgun) with reinforced ceramic materials could help improve their ablation resistance and penetration depth. Based on these examples the cost-effective synthesis of reinforced UHTC materials could satisfy many wide-ranging needs.

The following examples are given to illustrate specific applications. These specific examples are not intended to limit the scope of the disclosure in this application. Using the approach described above, a series of TiB₂ and B₄C ceramic samples have been prepared using different high temperature resins. A subset of those samples also contains reinforcement phases ranging from short chopped carbon and SiC fibers as well as woven fabric preforms. In some composites containing short chopped reinforcement phases, an epoxy resin was added to help adhere the precursor material to individual fibers and improve fiber dispersion throughout the sample. Carbon-carbon composites were made using an analogous method. It was also demonstrated that ceramic phases can be added to carbon-carbon composites to help modify properties. Select samples that highlight the versatility of this approach are described below.

### Example 1

TiB₂/Carbon Fiber—

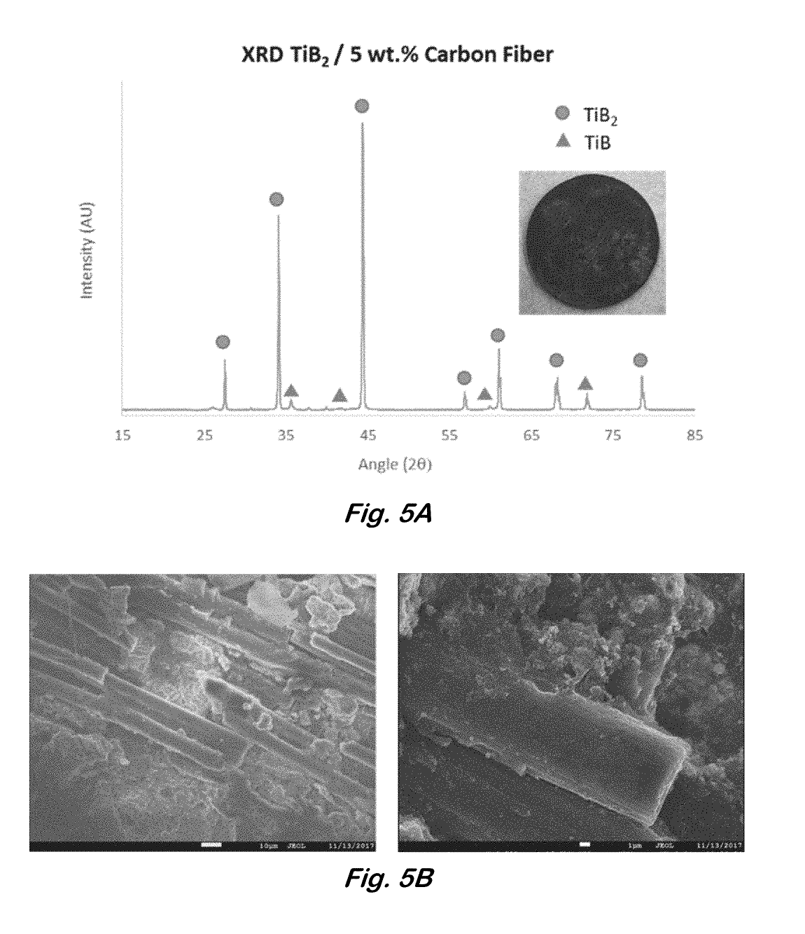

A precursor mixture for the synthesis of titanium diboride (TiB₂) was prepared using titanium, boron powder (B) in a 1:3.78 ratio, and 20 wt. % TPEB. The precursor mixture was then added to a suspension of chopped carbon fibers in ethanol such that the total carbon fiber loading was 5 wt. % of the total mixture. The solvent was then evaporated and the carbon fiber/precursor mixture was consolidated into a green body using a heated hydraulic press. Conversion to ceramic was done by heating sample in a tube furnace under flowing Ar. Powder x-ray diffraction (XRD) patterns of TiB₂ sample shown in FIG. 5A indicate that both TiB₂ and TiB phases were formed. However, the desired TiB₂ phase was predominately formed. Scanning electron microscope (SEM) images of the TiB₂ sample (FIG. 5b) show that carbon fibers are dispersed within the TiB₂ matrix and the TiB₂ composition was able to withstand the high pressures needed for consolidation of green body and extreme temperatures used to form the ceramic phase.

### Example 2

TiB₂/Woven Carbon Fiber—

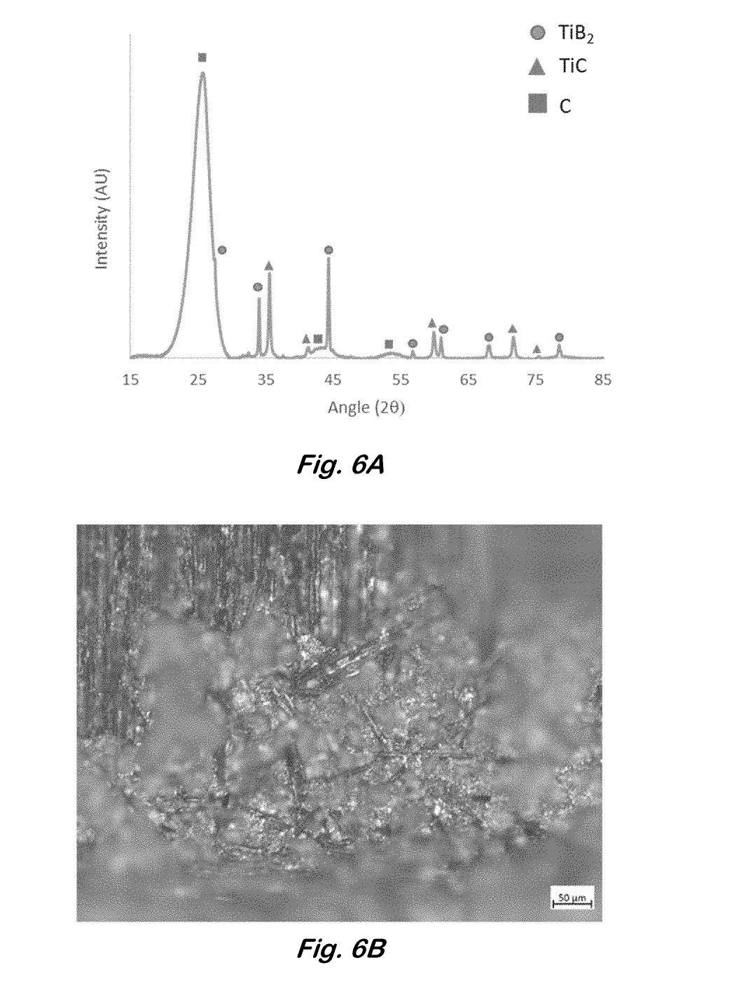

A precursor mixture containing Ti and B in a 1:3.78 ratio, and 20 wt. % TPEB was mixed together as previously described. The precursor was suspended in ethanol before painting on woven carbon fiber preforms. Circular pieces were cut from the larger preform and stacked together to form a 7 ply sample. Some TPEB resin was placed in between each layer to help sample adhesion during consolidation using a heated hydraulic press. The woven green body was then heated under an Ar atmosphere to form ceramic composite. The powder XRD patterns (FIG. 6A) indicate that TiB₂, TiC, and C phases are formed after heating the woven composite. Optical micrograph images show that the ceramic phase is adhered to the woven carbon fiber preform (FIG. 6B).

### Example 3

TiB₂/Phthalonitrile—

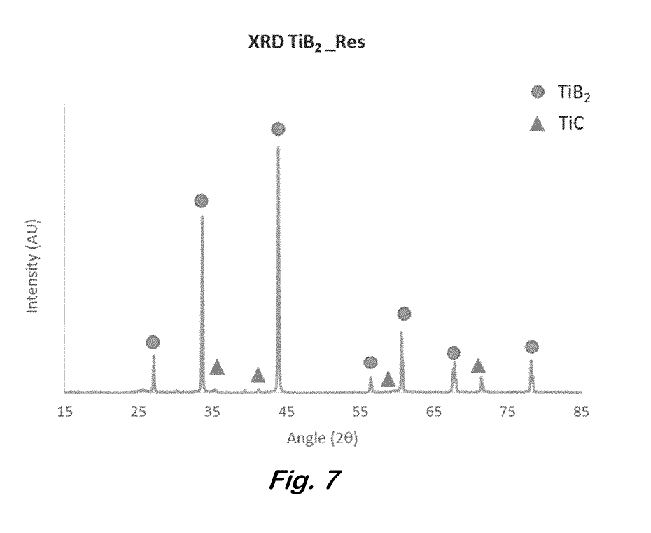

Precursor made from Ti and B in a 1:3.78 ratio, and 20 wt. % of a resorcinol based phthalonitrile resin (Res) using as previously described. The powder was pressed into a green body using a hydraulic press and converted to a ceramic by heating in a tube furnace under Ar atmosphere. The powder XRD pattern shows that the resorcinol (Res) resin can be used to form the TiB₂ ceramic phase (FIG. 7).

### Example 4

B/Phthalonitrile—

Precursor material was made by mixing resorcinol (Res) with boron powder in a 1:2.72 ratio as previously described. The precursor powder was pressed into a green body using a hydraulic press and converted to a ceramic by heating in a tube furnace under Ar atmosphere.

### Example 5

Woven Fiber/Phthalonitrile—

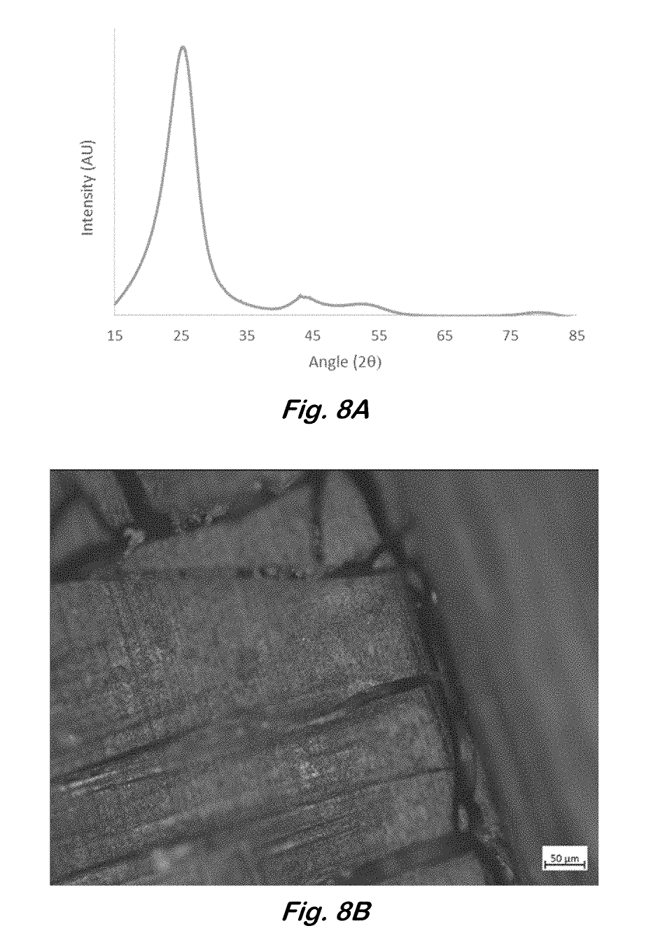

Woven fibers were impregnated with resorcinol (Res) resin by dipping fibers in a Res/acetone solution. The fiber performs (prepreg) were dried before consolidation of Res composite using a heated hydraulic press. Consolidation was done under vacuum in order to ensure flow of resin throughout the sample. The Res composite was heated in tube furnace under Ar to carbonize resin and form C/C composite. Powder XRD patterns (FIG. 8A) confirm the formation of a graphitic carbon and optical micrographs (FIG. 8B) show adhesion between carbon matrix and fiber preform.

### Example 6

Ti/Woven Fiber/Phthalonitrile—

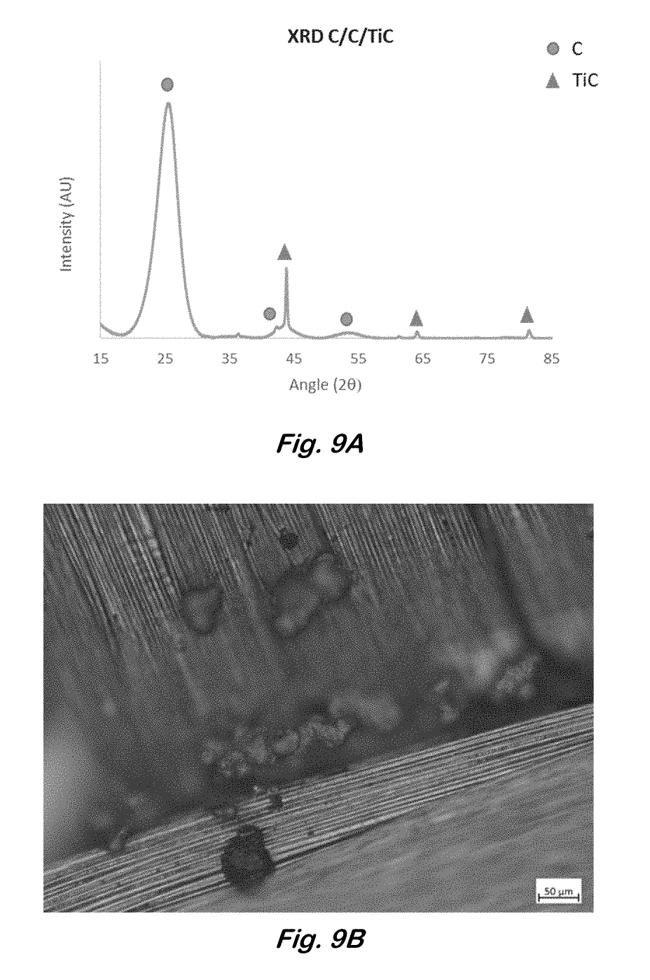

Woven fibers were impregnated with Res resin by submerging the fibers in a Res/acetone solution. After drying, the impregnated fibers were also coated with a Ti/Res powder to add in the ceramic precursor. The layers were consolidated and crosslinking of Res was done using a heated hydraulic press. Consolidation was done under vacuum in order to ensure flow of resin throughout the sample. The Res composite was heated in tube furnace under Ar to carbonize resin and form TiC—C/C composite. Powder XRD patterns (FIG. 9A) confirm the formation of a graphitic carbon as well as TiC. Optical micrographs show adhesion of carbon matrix and TiC with the reinforcing woven fibers (FIG. 9B).

### Example 7

Staging of TPEB of 1,2,4,5-tetrakis(phenylethynyl)benzene (TPEB)—

TPEB was placed in a glass Petri Dish and heated at 225° C. for 55 min. The staged TPEB was removed from the oven and cooled in air before grinding in a mortar and pestle.

### Example 8

Formulation of TiB₂ Ceramic Precursor with TPEB—

The staged TPEB described in Example 7 (1.426 g; 2.98 mmol), elemental titanium (3.995 g; 83.5 mmol), and elemental boron (1.775 g, 167.4 mmol) were ball milled together for 60 min. using stainless canisters and grinding media, and ethanol as the grinding lubricant. The solvent was evaporated in air.

### Example 9

Consolidation of Greenbody with 5 wt. % Carbon Fiber—

A suspension of chopped carbon fiber (0.106 g) in dichloromethane (10 mL) was prepared via continuous ultra-sonication for 30 min. The precursor powder described in Example 8 (1.912 g) and unstaged TPEB (0.059 g, 0.1 mmol) were added to the carbon fiber suspension while stirring. The mixture was stirred for an additional 30 min before evaporation in air and drying under vacuum for 1 hr. The resin thermoset was prepared by loading the reinforced precursor into a 25 mm steel die and pressing to 8000 pounds for 2 hours with a hydraulic press heated to 225° C.

### Example 10

Conversion of 5 wt. % Carbon Fiber Reinforced Greenbody into TiB₂ Ceramic Phase—

The greenbody described in Example 9 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450 for 1 hr. before slow cooling to room temperature at 3.5° C./min. Using this process, a reinforced TiB₂ ceramic was formed.

### Example 11

Consolidation of Greenbody Containing 10 wt. % Carbon Fiber—

Using a method similar to Example 9, a dichloromethane (10 mL) suspension containing carbon fiber (0.203 g) was prepared by ultra-sonication. The precursor powder described in Example 8 (1.810 g) and unstaged TPEB (0.47 g) were added to carbon fiber mixture while stirring, followed by evaporation of the solvent. The resin thermoset was prepared by loading the reinforced precursor into a 25 mm steel die and pressing to 8000 pounds for 2 hours with a hydraulic press heated to 225° C.

### Example 12

Conversion of 10 wt. % Carbon Fiber Reinforced Greenbody into TiB₂ Ceramic Phase—

The greenbody described in Example 11 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min. Using this process, a reinforced TiB₂ ceramic was formed.

### Example 13

Consolidation of Greenbody Containing 20 wt. % Carbon Fiber—

Using a method similar to Example 9, a dichloromethane (10 mL) suspension containing carbon fiber (0.404 g) was prepared by ultra-sonication. The precursor powder described in Example 8 (1.606 g) was added to carbon fiber mixture while stirring, followed by evaporation of the solvent and drying under vacuum. The resin thermoset was prepared by loading the reinforced precursor into a 25 mm steel die and pressing to 8000 pounds for 1.5 hours with a hydraulic press heated to 225° C.

### Example 14

Conversion of 20 wt. % Carbon Fiber Reinforced Greenbody into TiB₂ Ceramic Phase—

The greenbody described in Example 13 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min. Using this process, a reinforced TiB₂ ceramic was formed.

### Example 15

Consolidation of Greenbody Containing 5 wt. % Silicon Carbide Fiber—

Using a method similar to Example 9, an ethanol (10 mL) suspension containing silicon carbide fibers (0.100 g) was prepared by ultra-sonication. The precursor powder described in Example 8 (1.903 g) was added to silicon carbide fiber mixture while stirring, followed by evaporation of the solvent. The resin thermoset was prepared by loading the reinforced precursor into a 25 mm steel die and pressing to 8000 pounds for 1.5 hours with a hydraulic press heated to 225° C.

### Example 16

Conversion of 5 wt. % Silicon Carbide Reinforced Greenbody into TiB₂ Ceramic Phase—

The greenbody described in Example 15 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min. Using this process, a reinforced TiB₂ ceramic was formed.

### Example 17

Consolidation of Greenbody Containing 10 wt. % Silicon Carbide Fiber—

Using a method similar to Example 9, an ethanol (10 mL) suspension containing silicon carbide fibers (0.207 g) was prepared by ultra-sonication. The precursor powder described in Example 8 (1.796 g) was added to silicon carbide fiber mixture while stirring, followed by evaporation of the solvent. The resin thermoset was prepared by loading the reinforced precursor into a 25 mm steel die and pressing to 8000 pounds for 1.5 hours with a hydraulic press heated to 225° C.

### Example 18

Conversion of 10 wt. % Silicon Carbide Reinforced Greenbody into TiB₂ Ceramic Phase—

The greenbody described in Example 17 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min. Using this process, a reinforced TiB₂ ceramic was formed.

### Example 19

Consolidation of Greenbody Containing 20 wt. % Silicon Carbide Fiber—

Using a method similar to Example 9, an ethanol (10 mL) suspension containing silicon carbide fibers (0.409 g) was prepared by ultra-sonication. The precursor powder described in Example 8 (1.604 g) was added to silicon carbide fiber mixture while stirring, followed by evaporation of the solvent. The resin thermoset was prepared by loading the reinforced precursor into a 25 mm steel die and pressing to 8000 pounds for 1.5 hours with a hydraulic press heated to 225° C.

### Example 20

Conversion of 20 wt. % Silicon Carbide Reinforced Greenbody into Ceramic Phase—

The greenbody described in Example 19 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min. Using this process, a reinforced TiB₂ ceramic was formed.

### Example 21

Staging of TPEB for 65 Minutes—

TPEB was placed in a glass Petri Dish and heated at 225° C. for 65 min. The staged TPEB was removed from the oven and cooled in air before grinding in a mortar and pestle.

### Example 22

Formulation of TiB₂ Ceramic Precursor with TPEB—

The staged TPEB described in Example 21 (0.556 g; 1.16 mmol), elemental titanium (3.445 g, 72.0 mmol), and elemental boron (1.556 g, 143.9 mmol) were ball milled together for 60 min. using stainless canisters and grinding media, and ethanol as the grinding lubricant. The solvent was evaporated in air.

### Example 23

Impregnation of Woven Carbon Fiber Preform—

Unstaged TPEB (0.214) was dissolved in dichloromethane. Using a paint brush, both sides of the woven carbon fiber fabric (5.2 g) was coated with the TPEB/dichloromethane solution. A suspension of the TiB₂ precursor described in Example 22 (1.002 g) was prepared in dichloromethane. The resulting suspension was painted evenly across both sides of the woven carbon fiber preform. The impregnated fibers were dried in air for 20 min followed by drying in a vacuum oven for an additional 30 min.

### Example 24

Consolidation of TiB₂/TiC Ceramic Reinforced with Woven Carbon Fiber Preforms—

With scissors, a total of 7 circular plys (25 mm diameter) were cut from the fiber preform. As the plys were stacked into the steel die, a powder layer (0.030 g, comprised of the precursor powder described in Example 22 and the staged TPEB detailed in Example 7 ground together in a 1:1 ratio) was placed between each layer. Using a hydraulic press heated to 225° C., the sample was consolidated by applying 5000 pounds. Pressure and heat were applied for 1.5 hrs. to ensure formation of the thermoset.

### Example 25

Conversion of TiB₂/TiC Ceramic Reinforced with Woven Carbon Fiber Preform to Ceramic Phase—

The greenbody described in Example 24 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min. Using this process, a TiB₂/TiC ceramic was formed with a continuous reinforcement phase.

### Example 26

Preparation of Epoxy Resin and Curing Additive Stock Solutions—

Stock solutions of EPON 862 epoxy resin and the curing additive diethyltoluenediamine (DETDA) were both prepared before adding to precursor mixture. For the epoxy resin stock solution, EPON 862 (2.01 g) was dissolved in dichloromethane (10 mL) and sonicated for 20 min. Using the same procedure, a DETDA (2.01 g) stock solution was also dissolved in dichloromethane (10 mL).

### Example 27

Consolidation of Greenbody with 2.5 wt. % Carbon Fiber and Epoxy Resin—

A suspension of chopped carbon fiber (0.47 g) in ethanol (20 mL) was prepared via continuous ultra-sonication for 30 min. The precursor powder described in Example 8 (1.95 g) along with EPON 862 (0.25 mL of stock solution, 0.050 g) and DEDTA (5 μL of stock solution, 0.012 g) were added to the carbon fiber suspension while stirring. The mixture was sonicated for an additional 60 min before evaporation in air and drying under vacuum for 1 hr. The resin thermoset was prepared by loading the reinforced precursor into a 25 mm steel die and pressing to 8000 pounds for 1.5 hours with a hydraulic press heated to 225° C.

### Example 28

Conversion of Epoxy Cured TiB₂ Ceramic Reinforced with Woven Carbon Fiber Preform to Ceramic Phase—

The greenbody described in Example 27 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min. Using this process, a TiB₂ ceramic was formed reinforced with short chopped carbon fibers.

### Example 29

Staging of the Resorcinol Based Phthalonitrile Prepolymer Resin (Res)—

The Res resin was staged at 175° C. for 50 min under ambient conditions. The curing additive with m-BAPS (2.7 wt. %) was dry mixed along with the staged Res resin to form the prepolymer.

### Example 30

Formulation of TiB₂ Ceramic Precursor with Res—

The staged Res described in Example 29 (0.640 g; 0.9 mmol), elemental titanium (4.004 g; 83.6 mmol), and elemental boron (1.795 g, 166.0 mmol) were ball milled together for 60 min. using stainless canisters and grinding media, and ethanol as the grinding lubricant. The solvent was evaporated in air.

### Example 31

Consolidation of Greenbody Containing the TiB₂ Ceramic Precursor Derived from Res Resin—

The precursor powder described in Example 30 was loaded into a 25 mm steel die. A hydraulic press heated to 175° C. was used to consolidate the greenbody and form thermoset by applying 30,000 pounds of force.

### Example 32

Conversion of TiB₂ Greenbody Derived from Res Resin to Ceramic Phase—

The greenbody described in Example 31 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min. Using this process, a TiB₂ ceramic was formed reinforced with short chopped carbon fibers.

### Example 33

Impregnation of Carbon Fiber Preform with Res Resin—

An acetone (120 mL) solution was prepared of the resin described in Example 29 (46.43 g). Woven carbon fiber fabric was impregnated by submerging the fibers into the Res/acetone solution and drying in air. The remaining Res/acetone solution was painted evenly across the fibers.

### Example 34

Consolidation of Res Polymer Composite—

The impregnated woven carbon fibers described in Example 33 were cut into 8 plys (6″×6″) and dried at 70° C. When laying up the composite, the plys were oriented such the direction of the fibers were ran perpendicular to the subsequent layer. The resulting stack was then vacuum pressed using a heated hydraulic press to apply 1800 pounds of force. The sample was initially heated to 150° C. for 1 hour followed by removal of the vacuum. The composite was then heated to 175° C. and 225° C. and held for an hour at each temperature.

### Example 35

Conversion of Polymer Composite to Carbon/Carbon Composite—

A section of the polymer composite described in Example 34 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min. Using this process, a carbon/carbon composite was formed.

### Example 36

Impregnation of Carbon Fiber Preform with Res Resin and Elemental Titanium—

An acetone (300 mL) solution was prepared of the resin described in Example 29 (75.39 g). Woven carbon fiber fabric was impregnated by submerging the fibers into the Res/acetone solution and drying in air. The remaining Res/acetone solution was painted evenly across the fibers. A powder (15.06 g) comprising Res and elemental Ti mixed together in a 4:1 (Res:Ti) ratio was spread evenly across the fiber preform.

### Example 37

Consolidation of Res/Ti Polymer Composite—

The Res/Ti impregnated woven carbon fibers described in example 36 were cut into 6 plys (3″×3″) and dried at 70° C. When laying up the composite, the plys were oriented such the direction of the fibers were ran perpendicular to the subsequent layer. The resulting stack was then vacuum pressed using a heated hydraulic press to apply 1800 pounds of force. The sample was initially heated to 150° C. for 1 hour followed by removal of the vacuum. The composite was then heated to 175° C. and 225° C. and held for an hour at each temperature.

### Example 38

Conversion of Polymer Composite to Carbon/Carbon Composite with TiC Inclusions—

A section of the polymer composite described in Example 37 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min. Using this process, a carbon/carbon composite was formed.

### Example 39

Staging of TPEB for 37 Minutes—

TPEB was placed in a glass Petri Dish and heated at 225° C. for 37 min. The staged TPEB was removed from the oven and cooled in air before grinding in a mortar and pestle.

### Example 40

Impregnation of Carbon Fiber Preform with TPEB Resin—

A dichloromethane (150 mL) solution was prepared using the TPEB resin described in Example 39 (47.4 g). Woven carbon fiber fabric was impregnated by painting both sides of the fibers with the TPEB/dichloromethane solution and drying in air.

### Example 41

Consolidation of TPEB Polymer Composite—

The TPEB impregnated woven carbon fibers described in Example 40 were cut into 8 plys (6″×6″) and dried in a vacuum oven at 40° C. When laying up the composite, the plys were oriented such the direction of the fibers were ran perpendicular to the subsequent layer. The resulting stack was then vacuum pressed using a heated hydraulic press to apply 1800 pounds of force. The sample was initially heated to 175° C. for 1 hour followed by removal of the vacuum. The composite was then heated to 225° C. and held for 1.5 hours.

### Example 42

Carbonization of TPEB Composite to Form Carbon/Carbon Composite—

The sample described in Example 41 was placed in a 3″ tube furnace, heated at 2° C./min under a flow (100 cc/min) of argon to 1400° C., and held at 1400° C. for 1 hr., followed by additional heating at 1° C./min to 1450° C. The temperature was held at 1450° C. for 1 hr. before slow cooling to room temperature at 3.5° C./min.

### Example 43

Impregnation of Carbon Fiber Preform with TPEB/Res Resin Mixture—

A dichloromethane (175 mL) solution was prepared by dissolving a mixture of the TPEB resin (23.2 g) described in Example 39 and Res resin described in Example 29 (23.12 g). Woven carbon fiber fabric was impregnated by painting both sides of the fibers with the TPEB/Res/dichloromethane solution and drying in air.

### Example 44

Consolidation of TPEB Polymer Composite—

The TPEB/Res impregnated woven carbon fibers described in Example 43 were cut into 8 plys (6″×6″) and dried in a vacuum oven at 40° C. When laying up the composite, the plys were oriented such the direction of the fibers were ran perpendicular to the subsequent layer. The resulting stack was then vacuum pressed using a heated hydraulic press to apply 1800 pounds of force. The sample was initially heated to 165° C. for 1 hour followed by removal of the vacuum. The composite was then heated to 225° C. and held for 1.5 hours.

### Example 45

Carbonization of TPEB/Res Composite to Form Carbon/Carbon Composite—

The sample described in Example 44 was placed in a 3″ tube furnace, heated at 2° C./min under a flow (100 cc/min) of argon to 1000° C., and held at 1000° C. for 2 hr. The temperature was before slowly cooled to room temperature at 3.5° C./min.

Obviously, many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A composition comprising:
nanoparticles of a boron or refractory metal nitride, boride, or carbide;
a reinforcing material; and
a carbonaceous matrix;
wherein the composition is not in the form of a powder.

2. The composition of claim 1, wherein the nanoparticles comprise titanium boride, boron carbide, or titanium carbide.

3. The composition of claim 1, wherein the composition comprises at least 5% by weight of the nanoparticles.

4. The composition of claim 1, wherein the reinforcing material is carbon nanotubes, carbon fibers, or silicon carbide fibers.

5. The composition of claim 1, wherein the reinforcing material is woven fibers.

6. A composition comprising:
a metal component selected from: nanoparticles or particles of boron, a refractory metal, or a refractory metal hydride;
an organic component selected from:
an organic compound having a char yield of at least 60% by weight; and
a thermoset made from the organic compound; and
a reinforcing material.

7. The composition of claim 6, wherein the metal component is titanium and boron.

8. The composition of claim 6, wherein the organic component:
contains only carbon and hydrogen;
contains aromatic and acetylene groups;
contains only carbon, hydrogen, and nitrogen or oxygen;
contains no oxygen; or
contains a heteroatom other than oxygen.

9. The composition of claim 6, wherein the organic compound is 1,2,4,5-tetrakis(phenylethynyl)benzene or a prepolymer thereof, an epoxy, a phenolic, a phthalonitrile, or a polycarborane-silyloxyl-acetylene.

10. The composition of claim 6, wherein the reinforcing material is carbon nanotubes, carbon fibers, or silicon carbide fibers.

11. The composition of claim 6, wherein the reinforcing material is woven fibers.

12. A method comprising:
combining to form a precursor mixture:
a metal component selected from: nanoparticles or particles of boron, a refractory metal, or a refractory metal hydride; and
an organic compound having a char yield of at least 60% by weight; and
combining the precursor material with a reinforcing material.

13. The method of claim 12, wherein the precursor material is milled before combining with the reinforcing material.

14. The method of claim 12, wherein the metal component is titanium and boron.

15. The method of claim 12, wherein the organic compound:
contains only carbon and hydrogen;
contains aromatic and acetylene groups;
contains only carbon, hydrogen, and nitrogen or oxygen;
contains no oxygen; or
contains a heteroatom other than oxygen.

16. The method of claim 12, wherein the organic compound is 1,2,4,5-tetrakis(phenylethynyl)benzene or a prepolymer thereof, an epoxy, a phenolic, a phthalonitrile, or a polycarborane-silyloxyl-acetylene.

17. The method of claim 12, wherein the reinforcing material is carbon nanotubes, carbon fibers, or silicon carbide fibers.

18. The method of claim 12, wherein the precursor material is impregnated into a woven fiber reinforcing material.

19. The method of claim 12, further comprising:
heating the precursor material with reinforcing material to cure the organic compound to a thermoset; and
heating the thermoset in an inert atmosphere, argon, or nitrogen at a temperature that causes formation of a ceramic comprising boron or refractory metal nitride, boride, or carbide nanoparticles and the reinforcing material in a carbonaceous matrix.
